(19) United States
(12) Patent Application Publication
(10) Pub. No.: US 2017/0357863 A1
(43) Pub. Date: Dec. 14, 2017

(54) OBJECT DETECTION APPARATUS AND OBJECT DETECTION METHOD

(71) Applicant: DENSO CORPORATION, Kariya-city (JP)

(72) Inventors: Tomohiko TSURUTA, Nishio-city (JP); Naoki KAWASAKI, Nishio-city (JP); Kazuhisa ISHIMARU, Nishio-city (JP); Noriaki SHIRAI, Kariya-city (JP); Hirotake ISHIGAMI, Kariya-city (JP)

(21) Appl. No.: 15/617,636

(22) Filed: Jun. 8, 2017

(30) Foreign Application Priority Data
Jun. 10, 2016 (JP) 2016-116575

(51) Int. Cl. G06K 9/00; G06K 9/62; H04N 13/02; G06K 9/78; G06K 9/20; G06T 7/246; G06T 7/292

(52) U.S. Cl. CPC G06K 9/00805; G06T 7/248; G06K 9/6267; G06T 7/292; G06K 9/78; G06K 9/209; G06K 9/6215; H04N 13/0239; G06T 2207/10012; G06T 2207/30261

(57) ABSTRACT

In an object detection apparatus and an object detection method, as first and second images, captured images of an area ahead of a vehicle in a vehicle advancing direction are acquired from first and second imaging units provided in the vehicle. Based on the first and second images, whether or not an object is present in a blind spot ahead of the vehicle in the vehicle advancing direction is determined. When the object is determined to be present in the blind spot, the first and second images are held in time series. As first and second image differences, differences in a feature quantity between a previous image and a current image in the first and second images are acquired. Based on the first and second image differences, whether or not the object is approaching the area ahead of the vehicle is determined.

### CROSS-REFERENCE TO RELATED APPLICATION

This application is based on and claims the benefit of priority from Japanese Patent Application No. 2016-116575, filed Jun. 10, 2016. The entire disclosure of the above application is incorporated herein by reference.

### BACKGROUND

### Technical Field

The present disclosure relates to an object detection apparatus and an object detection method for detecting an object that is present ahead of a vehicle in an advancing direction of the vehicle.

### Related Art

An object detection apparatus that captures an image of an area ahead of a vehicle in an advancing direction of the vehicle by an imaging apparatus, such as a camera, and detects an object that suddenly appears ahead of the vehicle in the vehicle advancing direction from a position that is in a blind spot is known. The blind spot is a position at which the object is not visible from the vehicle. Through detection of the object that suddenly appears from the blind spot, the object detection apparatus is able to actuate various types of control to prevent collision with the object, based on the detection results.

In addition, JP-A-2013-210988 discloses an object detection apparatus that calculates a movement speed and a movement direction in the periphery of a blind spot in an image captured by an imaging apparatus. The movement speed and the movement direction serve as movement speed information. The object detection apparatus then determines whether or not an object has suddenly appeared from the blind spot based on the calculated movement speed information.

In cases in which whether or not an object has suddenly appeared is determined based on the movement speed and the movement direction of the object within a captured image, even when the actual movement directions of the object differ, the movement directions of the object in the image may be recognized as being the same. Specifically, the actual movement directions of the object differ between a case in which the object moves towards an own vehicle in a lateral direction of the own vehicle and a case in which the object moves ahead of the own vehicle in the vehicle advancing direction. However, in a two-dimensional image, the object moves towards the own vehicle in a left-right direction of the own vehicle in both cases. In such instances, the accuracy of determination regarding whether or not an object has suddenly appeared ahead of an own vehicle in a vehicle advancing direction from a blind spot may decrease. In addition, the amount of time required to perform a determination of an object suddenly appearing ahead of an own vehicle from a blind spot may increase.

### SUMMARY

It is thus desired to provide an object detection apparatus and an object detection method that are capable of performing, at an earlier timing and with high accuracy, detection of an object approaching ahead of an own vehicle from a blind spot.

An exemplary embodiment the present disclosure provides an object detection apparatus that includes: an image acquiring unit that acquires, as a first image, a captured image of an area ahead of a vehicle in a vehicle advancing direction from a first imaging unit provided in the vehicle and acquires, as a second image, a captured image of an area ahead of the vehicle in the vehicle advancing direction from a second imaging unit provided in the vehicle; a blind-spot determining unit that determines whether or not an object is present in a blind spot ahead of the vehicle in the vehicle advancing direction, based on the first image captured by the first imaging unit and the second image captured by the second imaging unit, the blind spot being an area that is visible through one of the first imaging unit and the second imaging unit and is not visible through the other of the first imaging unit and the second imaging unit; an image holding unit that holds the first image captured by the first imaging unit and the second image captured by the second imaging unit in time series, when the object is determined to be present in the blind spot; a difference acquiring unit that acquires, as a first image difference, a difference in a feature quantity between a previous image and a current image in the first image held in time series and acquires, as a second image difference, a difference in a feature quantity between a previous image and a current image in the second image held in time series; and an approach determining unit that determines whether or not the object is approaching the area ahead of the vehicle based on the first image difference and the second image difference acquired by the difference acquiring unit.

When a blind spot is present in an image captured by an imaging apparatus and an object is present in the blind spot, a situation occurs in that the object is visible in the first image captured by the first imaging unit and the object is not visible in the second image captured by the second imaging unit. In addition, the visibility of the object in the first image captured by the first imaging unit and the second image captured by the second imaging unit changes in time series, in accompaniment with the movement of the object. The manner in which the visibility changes is considered to change based on the movement direction.

In this regard, in the above-described configuration, the first image of a peripheral area including the blind spot captured by the first imaging unit is held in time series, the second image of a peripheral area including the blind spot captured by the first imaging unit is held in time series, the difference in feature quantity in the first image in the time series is calculated as the first image difference, and the difference in feature quantity in the second image in the time series is calculated as the second image difference. Then, whether or not the object is approaching the area ahead of the vehicle is determined based on the first image difference and the second image difference. In this case, the approach of the object can be determined taking into consideration that the manner of change in visibility of the object in the first image captured by the first imaging unit and the second image captured by the second imaging unit changes based on the movement direction of the object. Thus, a detection of an object approaching an area ahead of an own vehicle from a blind spot can be performed at an earlier timing and with high accuracy.

### BRIEF DESCRIPTION OF THE DRAWINGS

In the accompanying drawings:

FIG. 1 is a configuration diagram of a pre-crash safety system;

FIGS. 2A to 2C are diagrams for explaining imaging areas of a stereo camera;

FIGS. 3A and 3B are diagrams for explaining changes in a position of an object within captured images;

FIGS. 4A and 4B are diagrams for explaining a method for determining whether or not an object is present in a blind-spot area using the captured images;

FIG. 5 is a flowchart for explaining a determination of an object suddenly appearing ahead of an own vehicle from a blind spot;

FIGS. 6A and 6B are diagrams for explaining a method for determining whether or not an object is present in the blind-spot area;

FIGS. 7A to 7D are diagrams for explaining a determination of an object suddenly appearing ahead of an own vehicle from a blind spot;

FIGS. 8A to 8D are diagrams for explaining an operation for a determination of an object suddenly appearing ahead of an own vehicle from a blind spot, the determination being performed by an object detection electronic control unit (ECU);

FIGS. 9A to 9D are diagrams for explaining a method for determining whether or not an object is present in a blind spot, according to a second embodiment; and

FIGS. 10A and 10B are diagrams of variation examples of a first imaging unit and a second imaging unit.

### DESCRIPTION OF THE EMBODIMENTS

Embodiments of an object detection apparatus and an object detection method of the present disclosure will be described with reference to the drawings. Sections that are identical or equivalent to each other among the following embodiments are given the same reference numbers in the drawings. Descriptions of sections having the same reference numbers are applicable therebetween.

### First Embodiment

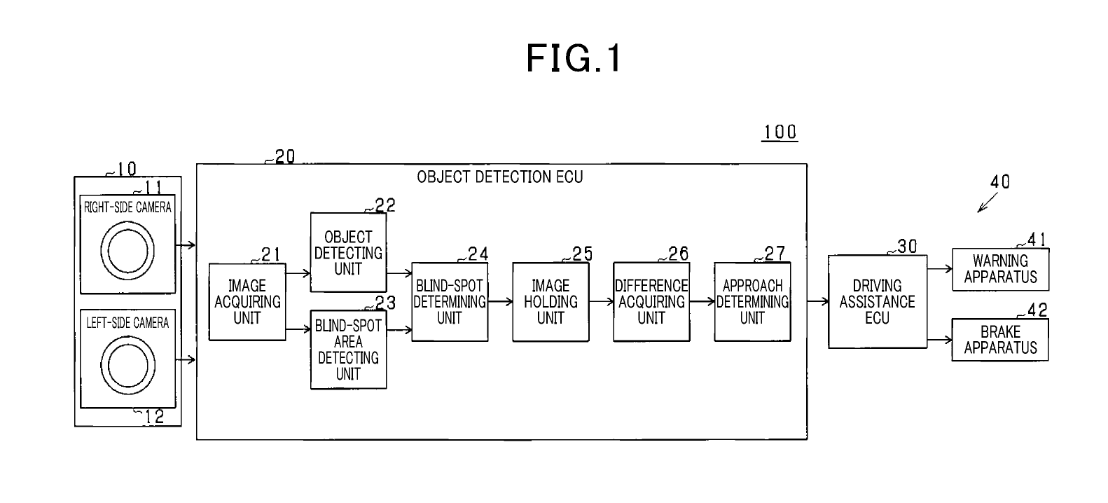

FIG. 1 shows a pre-crash safety system (referred to, hereafter, as PCSS) 100 to which the object detection apparatus and the object detection method are applied. The PCSS 100 is an example of a vehicle system that is, for example, mounted in a vehicle. The PCSS 100 detects an object ahead of the vehicle in an advancing direction of the vehicle. When there is risk of collision between the detected object and the vehicle, the PCSS 100 performs an operation to avoid collision between the vehicle and the object, or an operation to mitigate the collision. Hereafter, the vehicle in which the PCSS 100 is mounted is referred to as an own vehicle CS. An object to be detected is referred to as an object Ob.

As shown in FIG. 1, the PCSS 100 includes a stereo camera 10, an object detection electronic control unit (ECU) 20, a driving assistance ECU 30, and a control target 40. In the present embodiment shown in FIG. 1, the object detection ECU 20 functions as the object detection apparatus. In addition, the stereo camera 10 functions as an imaging apparatus.

The stereo camera 10 is set inside a vehicle cabin in a state in which an imaging axis faces ahead of the own vehicle CS, such that an area ahead of the own vehicle CS in the vehicle advancing direction can be imaged. In addition, the stereo camera 10 includes a right-side camera 11 and a left-side camera 12. The positions of the right-side camera 11 and the left-side camera 12 in the lateral direction differ. A right-side image captured by the right-side camera 11 and a left-side image captured by the left-side camera 12 are each outputted to the driving assistance ECU 30 at a predetermined cycle. For example, the right-side camera 11 and the left-side camera 12 are each configured by a charge-coupled device (CCD) image sensor or a complementary metal-oxide semiconductor (CMOS) image sensor. According to the first embodiment, the right-side camera 11 and the left-side camera 12 in the stereo camera 10 respectively function as a first imaging unit and a second imaging unit.

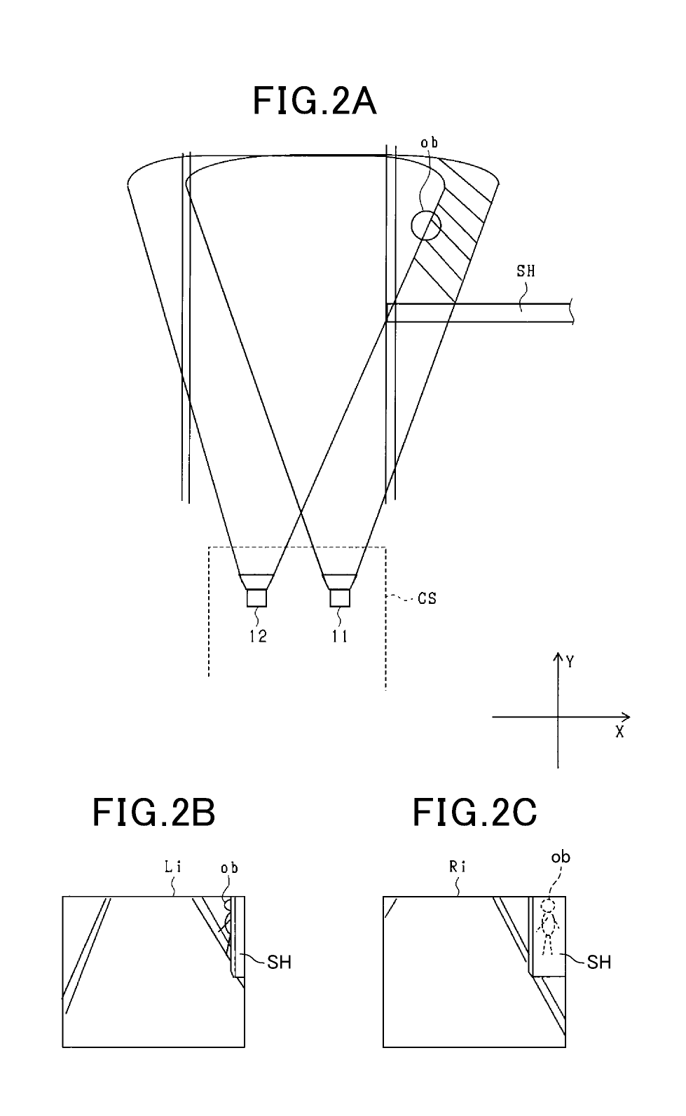

As shown in FIG. 2A, the right-side camera 11 and the left-side camera 12 are arranged so as to be respectively shifted to the right and to the left from the vehicle center, in a lateral direction (X-axis direction). Therefore, as shown in FIGS. 2B and 2C, a right-side image Ri, which corresponds to a first image, captured by the right-side camera 11 and a left-side image Li, which corresponds to a second image, captured by the left-side camera 12 differ regarding the angle from which the object Ob is viewed. Binocular parallax is generated. In the example shown in FIG. 2A, as a result of the binocular parallax, when a shielding object SH (that is a predetermined object) is present on the right-hand side in FIG. 2A, the right-side camera 11 cannot image the object Ob positioned in front of the shielding object SH (in the vehicle advancing direction). However, the left-side camera 12 can image the object Ob positioned in front of the shielding object SH.

The driving assistance ECU 30 performs PCS (collision avoidance control) to avoid collision with the object Ob by actuating the control target 40, based on a detection of the object Ob suddenly appearing ahead of the own vehicle CS, the determination being performed by the object detection ECU 20. The driving assistance ECU 30 is configured as a known microcomputer that includes a central processing unit (CPU), a read-only memory (ROM), and a random access memory (RAM).

In FIG. 1, a warning apparatus 41 and a brake apparatus 42 are provided as the control targets 40. A predetermined actuation timing is set for each control target 40. For example, the actuation timing of each control target 40 is set based on time-to-collision (TTC). Here, the TTC is an evaluation value indicating the number of seconds to collision between the own vehicle CS and the object Ob, when the own vehicle CS continues to travel at a current own-vehicle speed. The risk of collision increases as the TTC decreases. The risk of collision decreases as the TTC increases. For example, the driving assistance ECU 30 calculates the TTC by dividing a distance in a Y-axis direction from the own vehicle CS to the object Ob outputted from the object detection ECU 20 by a relative speed of the object Ob with reference to the own vehicle CS.

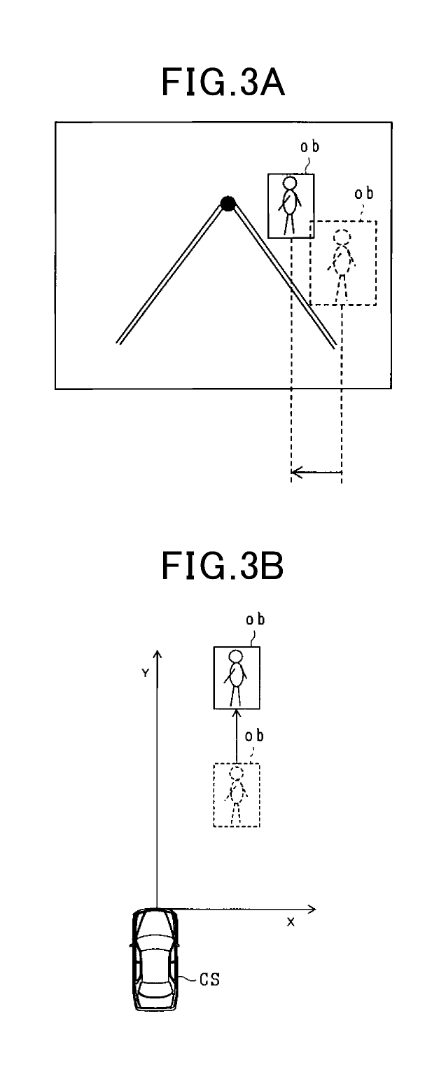

In the above-described PCS, a quick and accurate detection of the object Ob that suddenly appears (approaches) ahead of the own vehicle CS in the vehicle advancing direction, from a blind spot, is desirable. Meanwhile, even when the actual movement directions of the object Ob differ, the movement directions of the object Ob within a captured image may be recognized as being the same. FIGS. 3A and 3B show the difference between the actual movement direction and the movement direction within a captured image, in a case in which the object Ob present in a position shifted from the own vehicle CS in the lateral direction is moving in parallel to the advancing direction of the own vehicle CS. In FIGS. 3A and 3B, the object Ob before movement is indicated by broken lines. The movement direction is indicated by an arrow. For example, when the object Ob is moving in the same direction as the advancing direction of the own vehicle CS as shown in FIG. 3B, the position of the object Ob changes in the captured image so as to approach the area ahead of the own vehicle CS in the vehicle advancing direction, as shown in FIG. 3A. In the captured image, it appears as if the object Ob is moving in the lateral direction.

Consequently, for the determination of the object Ob suddenly appearing ahead of the own vehicle CS to be appropriately performed through use of the movement speed and the movement direction of the object Ob within a captured image, the difference between the actual movement of the object Ob and the movement of the object Ob within the captured image is required to be taken into consideration. Increase in the amount of time required for the determination becomes a concern. Therefore, the object detection ECU 20 includes the configurations shown in FIG. 1 to enable both the determination accuracy when the object Ob approaches the own vehicle CS to be maintained and the time required for the determination to be shortened.

Returning to FIG. 1, the object detection ECU 20 is configured as a known microcomputer that includes a CPU, a ROM, and a RAM. The object detection ECU 20 detects the object Ob based on the captured images captured by the stereo camera 10. In addition, the object detection ECU 20 runs programs stored in the ROM and thereby functions as an image acquiring unit 21, an object detecting unit 22, a blind-spot area detecting unit 23, a blind-spot determining unit 24, an image holding unit 25, a difference acquiring unit 26, and an approach determining unit 27.

The image acquiring unit 21 acquires the right-side image Ri and the left-side image Li respectively captured by the right-side camera 11 and the left-side camera 12. The image acquiring unit 21 receives a pair of captured images composed of the right-side image Ri and left-side image Li at a predetermined cycle. The pair of captured images is captured at the same imaging timing and outputted from the stereo camera 10.

The object detecting unit 22 detects the object Ob based on the images acquired from the right-side camera 11 and the left-side camera 12. For example, the object detecting unit 22 performs known template matching on the right-side image Ri and the left-side image Li, and detects objects Ob in the right-side image Ri and the left-side image Li. For example, in a case in which the object detecting unit 22 detects a pedestrian, the object detecting unit 22 detects the object Ob from the right-side image Ri and the left-side image Li using a predetermined dictionary for pedestrians. When the object detecting unit 22 detects a pedestrian by performing the template matching, a predetermined dictionary for detecting characteristics of the upper body of pedestrians may be used.

In addition, the object detecting unit 22 calculates a three-dimensional position of the object Ob based on the parallax between the right-side image Ri and the left-side image Li. For example, the object detecting unit 22 calculates the parallax between the right-side image Ri and the left-side image Li for each predetermined pixel block, and generates distance information based on the parallax of each pixel block. X-axis, Y-axis, and Z-axis distances of the object Ob are set in the distance information. In the distance information, the Z-axis is a position at which an up-down direction in actual space is a vertical direction.

The blind-spot area detecting unit 23 detects a blind spot ahead of the own vehicle CS in the vehicle advancing direction, based on the right-side image Ri and the left-side image Li. In the present embodiment, the blind spot is a position ahead of the own vehicle CS in the vehicle advancing direction at which an object Ob is not visible from a driver or the like of the own vehicle CS. Specifically, the blind spot is an area that is visible through one of the right-side camera 11 (corresponding to the first imaging unit) and the left-side camera 12 (corresponding to the second imaging unit) configuring the stereo camera 10 and is not visible through the other of the right-side camera 11 and the left-side camera 12.

According to the first embodiment, the blind spot includes a blind spot that is formed by a shielding object (predetermined object) SH such as buildings and signs alongside a travel road, or automobiles and the like. The blind-spot area detecting unit 23 detects, as a shielding object SH forming a blind-spot area DA1 that configures the blind spot, buildings and signs alongside a travel road, or automobiles and the like that have stopped alongside the travel road, in the right-side image Ri and the left-side image Li. For example, when a shielding object SH that is a candidate for causing the blind-spot area DA1 is detected from the right-side image Ri and the left-side image Li through use of the known template matching based on predetermined dictionaries for shielding objects forming the blind spot, the blind-spot area detecting unit 23 detects the blind-spot area DA1 based on the position of the shielding object SH. For example, when the shielding object SH that is a candidate for causing the blind-spot area DA1 is detected, the blind-spot area detecting unit 23 sets an area obtained by extending the position occupied by the shielding object SH within the image by a predetermined length in the lateral direction, as the blind-spot area DA1.

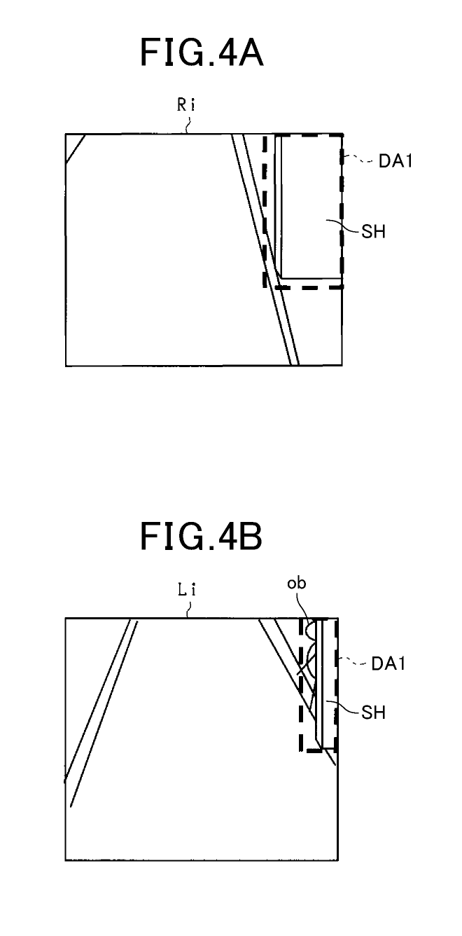

The blind-spot determining unit 24 determines whether or not a blind spot is present, and whether or not an object is present in the blind spot. For example, as shown in FIGS. 4A and 4B, in a case in which the blind-spot area DA1 is detected in the right-side image Ri and the left-side image Li, when an applicable object Ob is detected in the blind-spot area DA1 in either of the right-side image Ri and the left-side image Li, the blind-spot determining unit 24 determines that the object Ob is present in the blind-spot area DA1. In the example in FIGS. 4A and 4B, the object Ob is not detected in the blind-spot area DA1 in the right-side image Ri (FIG. 4A). However, the object Ob is detected in the blind-spot area DA1 in the left-side image Li (FIG. 4B). Therefore, the blind-spot determining unit 24 determines that the object Ob is present in the blind-spot area DA1.

Hereafter, an image in which an object Ob is not detected in a blind spot is referred to as a non-visible image. An image in which an object Ob is detected in the periphery of a blind spot is referred to as a visible image. For example, in FIGS. 4A and 4B, the right-side image Ri in which the object Ob is not detected in the blind-spot area DA1 is the non-visible image. The left-side image Li in which the object Ob is detected in the blind-spot area DA1 is the visible image.

The image holding unit 25 holds images of the periphery of a blind spot captured by the stereo camera 10 in time-series, when the blind spot determining unit 24 determines that an object Ob is present in the blind spot.

The difference acquiring unit 26 acquires a feature quantity in the time-series images held in the image holding unit 25 as an image difference including a first image difference and a second image difference. For example, the difference acquiring unit 26 acquires the first image difference between a previous image and a current image in the right-side image Ri related to the presence-absence of the object Ob in the right-side image Ri, and acquires the second image difference between a previous image and a current image in the left-side image Li as information related to the presence-absence of the object Ob in the left-side image Li.

The approach determining unit 27 determines whether or not the object Ob is approaching the area ahead of the own vehicle CS in the vehicle advancing direction, based on the first image difference and the second image difference acquired by the difference acquiring unit 26. As a result of the object Ob suddenly appearing from a blind spot in the lateral direction, the position of the object Ob changes from a position at which the presence-absence of the object Ob can be detected by either of the right-side camera 11 and the left-side camera 12 to a position at which the presence-absence of the object Ob can be detected by both the right-side camera 11 and the left-side camera 12. Therefore, whether or not the object Ob is approaching the area ahead of the own vehicle CS in the vehicle advancing direction can be determined based on the detection results regarding the presence-absence of the object Ob in the periphery of the blind spot in the right-side image Ri and the left-side image Li.

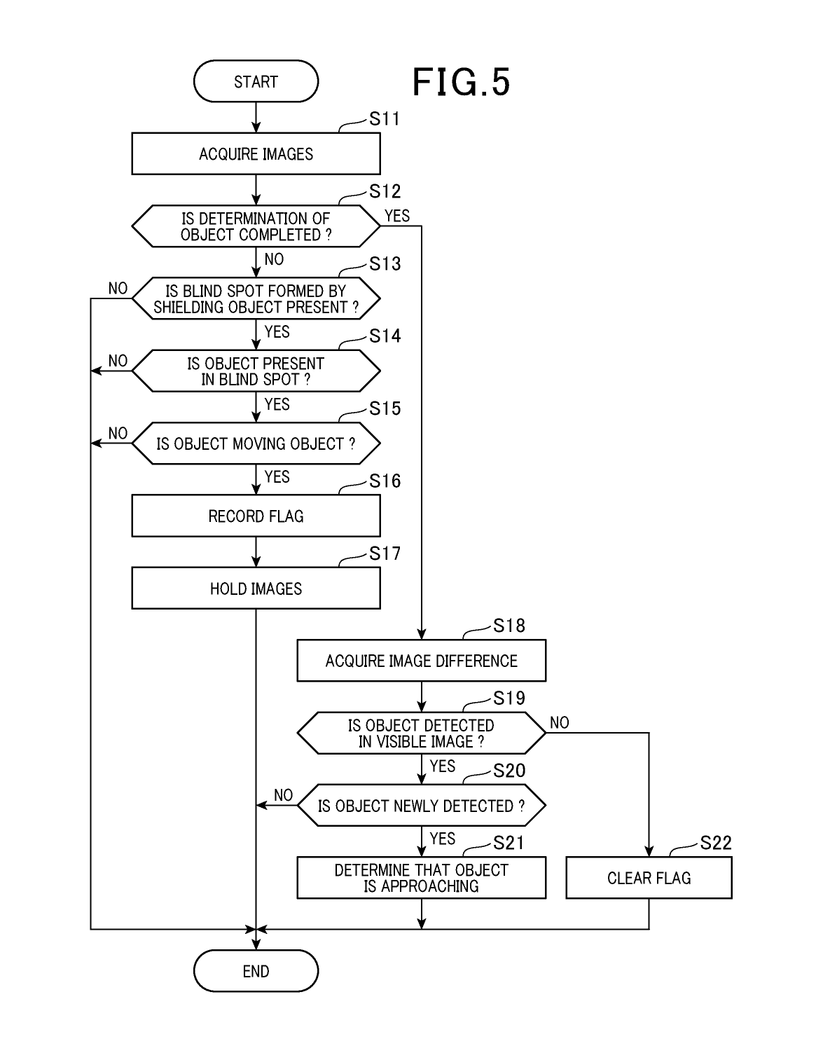

Next, a determination of the object Ob suddenly appearing (approaching) ahead of the own vehicle CS will be described with reference to the flowchart in FIG. 5. The series of processes shown in FIG. 5 is performed by the object detection ECU 20 at a predetermined cycle. Hereafter, the series of processes in FIG. 5 performed in a cycle following the performance of the series of processes shown in FIG. 5 is referred to as a next series of processes, and thereby differentiated from a current series of processes.

At step S11, the object detection ECU 20 acquires a pair of right-side image Ri and left-side image Li from the stereo camera 10. The imaging timings of the right-side image Ri and the left-side image Li are the same. Therefore, step S11 functions as an image acquiring step.

At step S12, the object detection ECU 20 determines a state flag that indicates that an object Ob is present in a blind-spot area DA1. The object detection ECU 20 initially proceeds to step S13 under a presumption that the determination regarding whether or not an object Ob is present in a blind-spot area DA1 has not been performed.

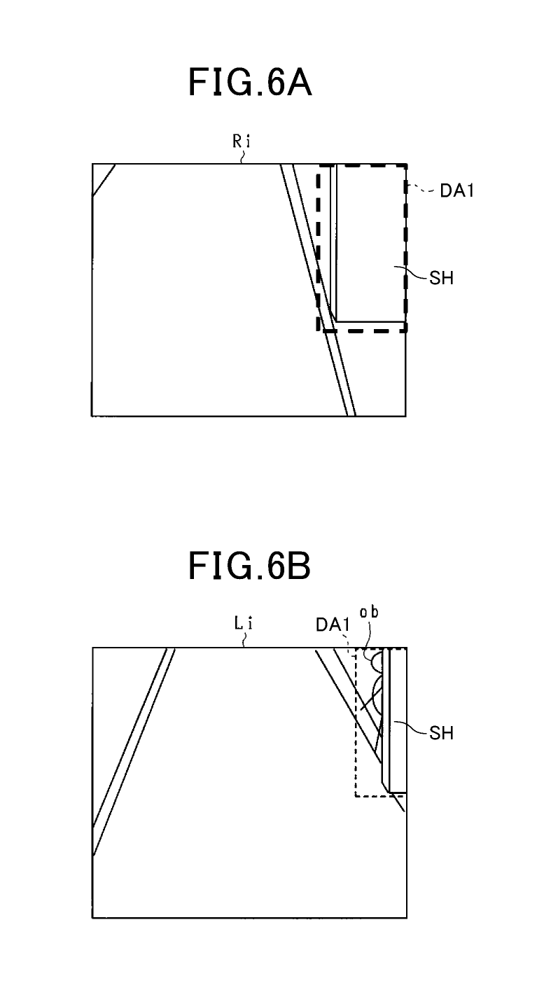

At step S13, the object detection ECU 20 determines whether or not a blind spot formed by a shielding object SH is present in the right-side image Ri and the left-side image Li. For example, in FIGS. 6A and 6B, the object detection ECU 20 detects a shielding object SH forming a blind-spot area DA1 in the right-side image Ri and the left-side image Li, and determines that a blind spot formed by a shielding object SH is present.

When determined that a blind-spot area DA1 formed by a shielding object SH cannot be detected from the right-side image Ri and the left-side image Li (NO at step S13), the object detection ECU 20 temporarily ends the series of processes in FIG. 5. Meanwhile, when determined that a blind-spot area DA1 formed by a shielding object SH is present in the right-side image Ri and the left-side image Li (YES at step S13), the object detection ECU 20 proceeds to step S14. According to the present embodiment, an example in which a single blind-spot area DA1 formed by a shielding object SH is present in the right-side image Ri will be described for ease of description.

At step S14, the object detection ECU 20 determines whether or not an object Ob is present in the blind-spot area DA1 formed by the shielding object SH. The object detection ECU 20 detects all objects Ob, including pedestrians, that are subject to the approach determination in the blind-spot area DA1. For example, in FIGS. 6A and 6B, the blind-spot area DA1 formed by the shielding object SH is present in both the right-side image Ri and the left-side image Li. In addition, a pedestrian subject to the approach determination is detected in the blind-spot area DA1 in the left-side image Li. Therefore, in the example in FIGS. 6A and 6B, the object detection ECU 20 determines that an object Ob is present in the blind-spot area DA1.

When determined that an object Ob is not detected in the blind-spot area DA1 (NO at step S14), the object detection ECU 20 temporarily ends the series of processes in FIG. 5. Meanwhile, when determined that an object Ob is detected in the blind-spot area DA1 (YES at step S14), the object detection ECU 20 proceeds to step S15. Steps S13 and S14 function as a blind-spot determining step.

At step S15, the object detection ECU 20 determines whether or not the object Ob detected at step S14 is a moving object. A reason for this is that, even when the object Ob is detected at step S14, should the object Ob be a stationary object that does not move, the likelihood of the object Ob suddenly appearing ahead of the own vehicle CS in the vehicle advancing direction is low. For example, stationary objects include utility poles and traffic cones. When determined that the detected object Ob is not a moving object (NO at step S15), the object detection ECU 20 temporarily ends the series of processes in FIG. 5.

Meanwhile, when determined that the object Ob detected at step S14 is a moving object (YES at step S15), the object detection ECU 20 proceeds to step S16. For example, when the pedestrian is detected as a moving object, the object detection ECU 20 determines that the object Ob detected at step S14 is a moving object. Therefore, step S15 functions as a moving-object determining unit and a type determining unit.

At step S16, the object detection ECU 20 stores the state flag indicating that an object Ob is present in a blind spot area DA1 formed by a shielding object SH.

At step S17, the object detection ECU 20 holds the right-side image Ri and the left-side image Li respectively captured by the right-side camera 11 and the left-side camera 12, as images of a peripheral area including a blind spot area DA1 formed by a shielding object SH. Therefore, peripheral images including the blind-spot area DA1 formed by the shielding object SH are held in time series for the right-side images Ri and the left-side images Li. The holding of the images at step S17 is continued while the state flag is being recorded. Step S17 functions as an image holding step. The object detection ECU 20 then temporarily ends the series of processes shown in FIG. 5.

Next, when determined that the state flag indicating that an object Ob is present in a blind-spot area DA1 formed by a shielding object SH is recorded at step S12 in the next series of processes (YES at step S12), the object detection ECU 20 proceeds to step S18.

At step S18, the object detection ECU 20 acquires a first image difference of the right-side images Ri of which holding has been started at step S17 and acquires a second image difference of the left-side images Li of which holding has been started at step S17. The first image difference is information indicating the difference between the previous image and the current image in the right-side images Ri. The second image difference is information indicating the difference between the previous image and the current image in the left-side images Li. Here, the first image difference and the second image difference are whether or not the object Ob is present in the periphery of the blind-spot area DA1. Step S18 functions as a difference acquiring step.

At step S19, the object detection ECU 20 determines whether or not the object Ob continues to be present in the image (visible image) in which the object Ob has been determined to be present at step S14 based on the acquisition result at step S18. When determined that the object Ob is not continuously present (NO at step S19), the object detection ECU 20 determines that the object Ob has moved to a position that cannot be imaged by the right-side camera 11 and the left-side camera 12. At step S22, the object detection ECU 20 deletes the state flag. The object detection ECU 20 then temporarily ends the process shown in FIG. 5.

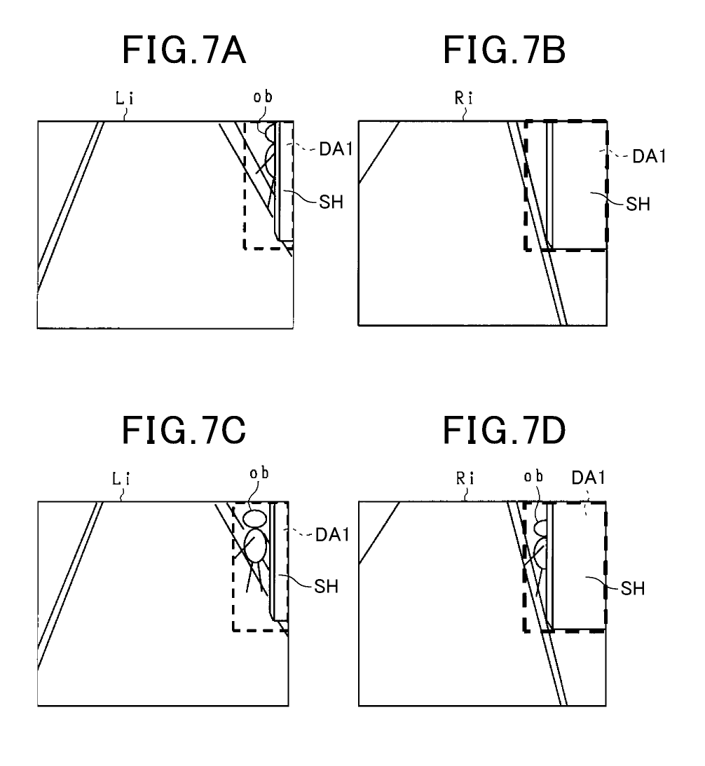

When determined that the object Ob is continuously present in the visible image (YES at step S19), at step S20, the object detection ECU 20 determines whether or not the object Ob is detected in the periphery of the blind-spot area DA1 formed by the shielding object SH in the image (non-visible image) in which the object Ob has not been detected in the blind spot at step S14. FIGS. 7A and 7B shows changes in the images in time series when the object Ob present in the blind-spot area DA1 formed by the shielding object SH does not approach the area ahead of the own vehicle CS in the vehicle advancing direction. In addition, FIGS. 7C and 7D shows changes in the images in time series when the object Ob present in the blind-spot area DA1 formed by the shielding object SH approaches the area ahead of the own vehicle CS in the vehicle advancing direction.

After the object Ob is detected in the visible image (the left-side image Li in FIGS. 7A to 7D), when the object Ob has not moved from the blind-spot area DA1 formed by the shielding object SH or is moving in the vehicle advancing direction (Y-axis direction), the object Ob is detected in the visible image but is not detected in the periphery of the blind-spot area DA1 formed by the shielding object SH in the non-visible image (right-side image Ri), as shown in FIGS. 7A and 7B. Meanwhile, when the object Ob is moving in the direction approaching the area ahead of the own vehicle CS in the vehicle advancing direction, the object Ob is detected in both the right-side image Ri and the left-side image Li, as shown in FIGS. 7C and 7D.

Therefore, when determined that the object Ob is not detected in the periphery of the blind-spot area DA1 formed by the shielding object SH in the non-visible image in which the object Ob has not been detected at step S14 (NO at step S20), the object detection ECU 20 determines that the object Ob is not approaching the area ahead of the own vehicle CS in the vehicle advancing direction and temporarily ends the series of processes shown in FIG. 5.

Meanwhile, when determined that the object Ob is detected in the periphery of the blind-spot area DA1 formed by the shielding object SH in the image that had been the non-visible image (YES at step S20), at step S21, the object detection ECU 20 determines that the object Ob is an object that is approaching the area ahead of the own vehicle CS in the vehicle advancing direction. Steps S19 to S21 function as an approach determining step. Upon completing the process at step S21, the object detection ECU 20 temporarily ends the series of processes shown in FIG. 5.

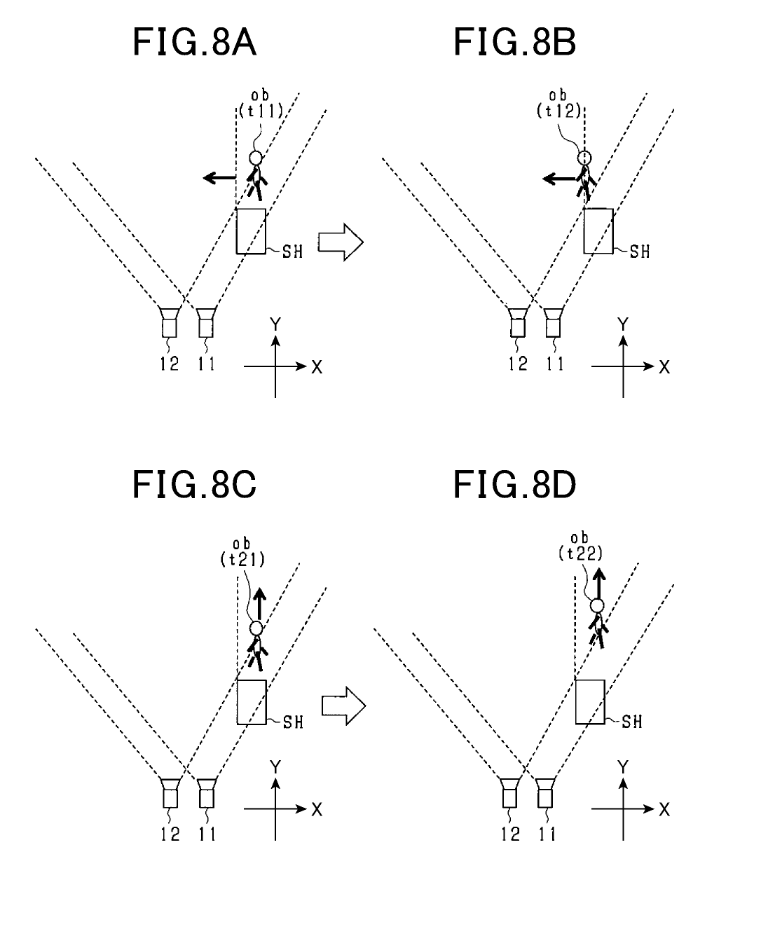

Next, operation of the approach determination performed by the object detection ECU 20 will be described with reference to FIGS. 8A to 8D. In FIGS. 8A to 8D, a shielding object SH is a stationary object that is present at the shoulder of a travel road on which the own vehicle CS is traveling. A blind spot in which an object Ob cannot be recognized from the own vehicle CS is formed in the area ahead of the shielding object SH (i.e., stationary object). In addition, FIGS. 8A and 8B are diagrams of a case in which a pedestrian serving as the object Ob suddenly appears from the blind-spot area. Meanwhile, FIGS. 8C and 8D are diagrams of a case in which the pedestrian is moving ahead of the own vehicle CS in the vehicle advancing direction, within a blind-spot formed by the shielding object SH.

As shown in FIG. 8A, when the shielding object SH is present ahead of the own vehicle CS in the vehicle advancing direction, the object detection ECU 20 determines the presence of the blind spot based on the position of the shielding object SH within the captured image. Then, a pedestrian Ob (t11) that is present in the blind spot enters the imaging area of the left-side camera 12 at time t11, and the object detection ECU 20 determines that the object Ob (i.e., pedestrian) is present in the blind spot formed by the shielding object SH.

Subsequently, the object Ob (i.e., pedestrian) moves in the direction approaching the area ahead of the own vehicle CS in the vehicle advancing direction, in the lateral direction (X-axis direction). As a result, at time t12 shown in FIG. 8B, the pedestrian Ob (t12) has moved to a position that can be imaged by both the right-side camera 11 and the left-side camera 12. Therefore, the object detection ECU 20 determines that the object Ob (i.e., pedestrian) is a moving object that is approaching the area ahead of the own vehicle CS in the vehicle advancing direction, from the blind spot formed by the shielding object SH. For example, as a result of the object Ob (i.e., pedestrian) being determined to be a moving object, the driving assistance ECU 30 actuates the warning apparatus 41 and warns the driver of suddenly appearing of the pedestrian.

Meanwhile, in FIG. 8C, the position of the object Ob (i.e., pedestrian) present in the blind spot at time t21 is within the imaging area of the left-side camera 12. Therefore, the object detection ECU 20 determines that the pedestrian Ob (i.e., pedestrian) is present in the blind spot. Subsequently, the object Ob moves in the direction away from the own vehicle CS in the vehicle advancing direction (Y-axis direction). As a result, the object Ob (i.e., pedestrian) at time t22 shown in FIG. 8D is present in a position that can be imaged by the left-side camera 12. Therefore, the object detection ECU 21 does not determine that the object Ob (i.e., pedestrian) is a moving object that is approach the area ahead of the own vehicle CS in the vehicle advancing direction and does not actuate the control target 40.

As described above, in the object detection ECU 20 according to the first embodiment, when an object Ob is determined to be present in a blind spot based on the difference in visibility of the object Ob between the right-side camera 11 and the left-side camera 12, the images of the peripheral area including the blind spot captured by the right-side camera 11 and the left-side camera 12 are held in time series. The difference in the feature quantities of the images in the time series is acquired as the image difference. Then, based on the image difference, whether or not the object Ob is approaching the area ahead of the own vehicle CS in the vehicle advancing direction is determined.

Therefore, the approach of the object Ob can be accurately determined, taking into consideration that the manner of change in visibility of the object Ob in the captured images of the right-side camera 11 and the left-side camera 12 changes based on the movement direction of the object Ob. In addition, as a result of determination of whether or not the object Ob is approaching the own vehicle CS based on the differences in feature quantities of the object Ob present in the periphery of the blind spot, the time required for the approach determination can be shortened. The determination timing can be made earlier.

The object detection ECU 20 determines that the object Ob is approaching the area ahead of the own vehicle CS in the vehicle advancing direction when, in the visible image, a state in which the object Ob is visible is recognized as being maintained based on the first image difference and the second image difference and, in the non-visible image, a state in which the object Ob is not visible is recognized as having changed to a state in which the object Ob is visible based on the first image difference and the second image difference. The visible image is an image (i.e., one of the first image and the second image) in which the object Ob is visible, among the captured images of the right-side camera 11 and the left-side camera. The non-visible image is an image (i.e., the other of the first image and the second image) in which the object Ob is not visible. As a result of the above-described configuration, the movement of the object can be determined based on the differences in visibility of the object Ob in the right-side images Ri and the left-side images Li. Therefore, determination accuracy of the approach determination regarding the object Ob can be improved.

When determined that an image captured by either of the right-side camera 11 and the left-side camera 12 is a visible image and the other images are non-visible images, the object detection ECU 20 determines whether or not the object Ob present in a blind spot in the visible image is a moving object that is moving. Then, when determined that the object Ob present in the blind spot in the visible image is a moving object, the object detection ECU 20 determines whether or not the object Ob is approaching the area ahead of the own vehicle CS in the vehicle advancing direction. Even when the object Ob is a stationary object that does not move, the position of the object Ob within the angle of view changes as a result of the own vehicle CS traveling. The position in the lateral direction of the object Ob within the image changes. Therefore, whether or not the object Ob is approaching the own vehicle CS is determined under a condition that the object Ob is a moving object that is moving. As a result of the above-described configuration, a stationary object can be eliminated from objects subject to the approach determination. Therefore, determination accuracy of the approach determination can be improved.

The object detection ECU 20 determines at least a pedestrian as the type of object Ob present in the blind spot. Under a condition that the object Ob is a pedestrian, the object detection ECU 20 determines whether or not the object Ob is present at the blind spot. The movement speed of a pedestrian is slower than that of an automobile or the like. Therefore, suddenly appearing of the pedestrian based on the movement speed may not be appropriately determined. Consequently, the object Ob is determined as a candidate object under a condition that the object Ob is a pedestrian. As a result of the above-described configuration, the approach determination can be appropriately performed even regarding a pedestrian having a slow movement speed.

### Second Embodiment

According to a second embodiment, instead of detecting a blind-spot area DA1 formed by a shielding object SH within an image and determining whether or not an object Ob is present within the blind-spot area DA1 formed by the shielding object SH, the object detection ECU 20 determines whether or not an object Ob is present in a blind spot based on visibility of an object Ob in a predetermined area within the image. In the second embodiment, the blind spot is an area that is visible through one of the right-side camera 11 (first imaging unit) and the left-side camera 12 (second imaging unit) configuring the stereo camera 10 and is not visible through the other of the right-side camera 11 and the left-side camera 12.

When an object Ob is detected only in a predetermined section in either of the right-side image Ri and the left-side image Li as a result of the difference in imaging direction between the right-side camera 11 and the left-side camera 12, a determination can be made that an object Ob is present in a blind spot that is present on either of the right and left sides of the area ahead of the own vehicle CS in the vehicle advancing direction.

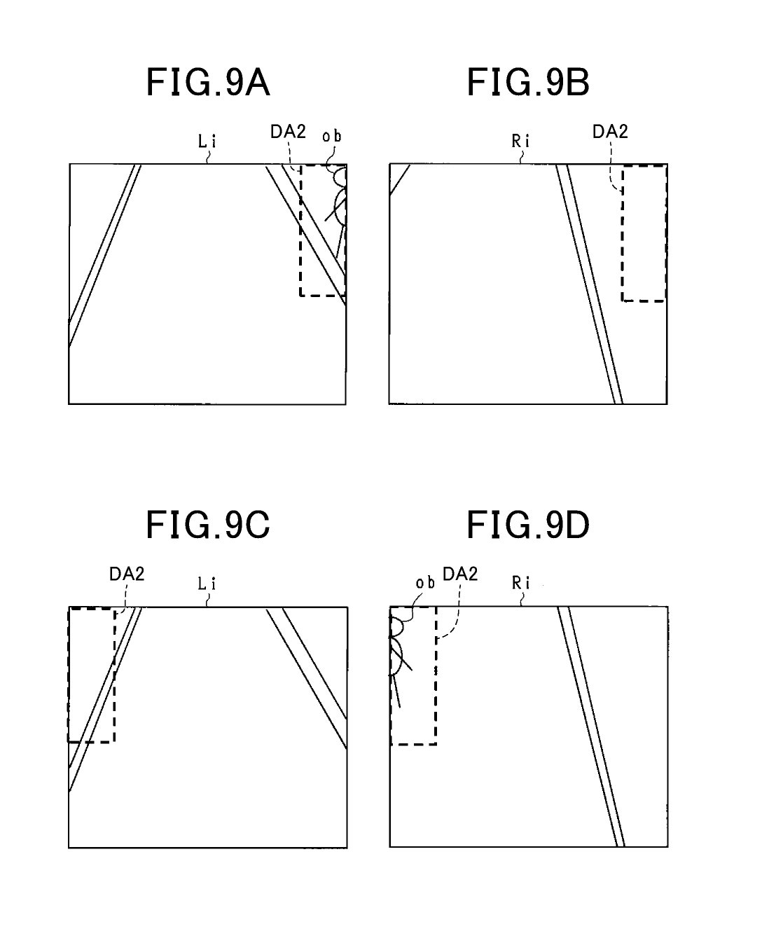

For example, in FIGS. 9A and 9B, the object Ob is detected at the right end in the left-side image Li. The object Ob is not detected at the right end in the right-side image Ri. Therefore, according to the second embodiment, the blind-spot determining unit 24 determines that an object Ob is present in a blind spot that is present on the right side in the advancing direction of the own vehicle CS.

In a similar manner, as shown in FIGS. 9C and 9D, when an object Ob is detected at the left end in the right-side image Ri and the same object Ob is not detected at the left end in the left-side image Li, the blind-spot determining unit 24 determines that an object Ob is present in a blind spot that is present on the left side in the advancing direction of the own vehicle CS.

Therefore, at step S13 in FIG. 5, the object detection ECU 20 sets the right end or the left end in the right-side image Ri and the left-side image Li as a detection area DA2 for detecting the blind spot, instead of detecting the blind-spot area DA1.

For example, in FIGS. 9A to 9D, the detection area DA2 is indicated by broken lines. At step S14 in FIG. 5, when an object Ob is detected in a detection area DA2 set at the right end in the left-side image Li and the object Ob is not detected in a detection area DA2 set at the right end in the right-side image Ri, or the object Ob is detected in a detection area DA2 set at the left end in the right-side image Ri and the object Ob is not detected in a detection area DA2 set at the left end in the left-side image Li, the object detection ECU 20 determines that the object Ob is present in a blind spot that is present on the right side or left side in the advancing direction of the own vehicle CS. The object detection ECU 20 then determines whether or not the object Ob is approaching the area ahead of the own vehicle CS in the vehicle advancing direction based on the image difference in the right-side images Ri and the image difference in the left-side images Li.

As described above, according to the second embodiment, whether or not an object Ob is present in a blind spot that is present ahead of the own vehicle CS can be detected, even when a shielding object SH configuring the blind spot is not present in the right-hand image Ri and the left-hand image Li.

### Other Embodiments

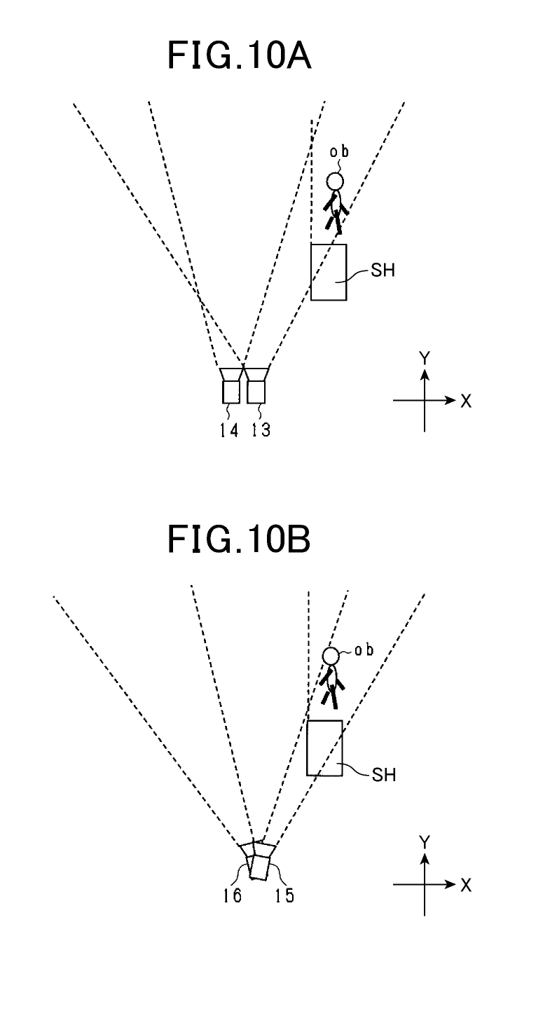

The first imaging unit and the second imaging unit may be configured by camera apparatuses having differing angles of view. In FIG. 10A, cameras 13 and 14 having differing angles of view are arranged in the lateral direction of the own vehicle CS. Of the cameras 13 and 14, the wide-angle camera 13 has a wider angle of view than the narrow-angle camera 14. The wide-angle camera 13 is capable of imaging areas to the left and right of the own vehicle CS that the narrow-angle camera 14 is unable to image.

In the camera apparatuses of the configuration shown in FIG. 10A, when the blind spot is present to the right or left of the own vehicle CS and the object Ob is present in the blind spot, the object Ob may be present within the angle of view of the wide-angle camera 13 and outside of the angle of view of the narrow-angle camera 14. Therefore, at step S14 in FIG. 5, when the object Ob is detected in the image from the wide-angle camera 13 and the object Ob is not detected in the image from the narrow-angle camera 14, the object detection ECU 20 determines that the object Ob is present in the blind spot that is present ahead of the own vehicle CS.

The blind-spot area detecting unit 23 may use parallax matching information for generating a parallax image based on the right-side image Ri and the left-side image Li. When the parallax image cannot be acquired, the blind-spot area detecting unit 23 determines that there is a difference between the right-side image Ri and the left-side image Li, and the blind-spot area is present.

In FIG. 10A, the wide-angle camera 13 and the narrow-angle camera 14 have differing imaging axes in the lateral direction of the own vehicle CS. However, the wide-angle camera 13 and the narrow-angle camera 14 may be arranged to have differing imaging axes in an up-down direction of the own vehicle CS. In addition, as shown in FIG. 10B, a camera 15 and a camera 16 having the same angle of view may be arranged in the up-down direction of the own vehicle CS. The camera 15 and the camera 16 may be arranged such that the orientations of the imaging axes thereof differ. In this case as well, at step S14 in FIG. 5, when the object Ob is detected at the right end of the image captured by the camera 15 and the object Ob is not detected at the right end of the image captured by the camera 16, for example, the object detection ECU 20 determines that the object Ob is present in the blind spot that is present ahead of the own vehicle CS.

The area of the object Ob may be used as the difference between the previous image and the current image in the right-side images Ri and the difference between the previous image and the current image in the left-side image Li. As a result of the object Ob moving from the blind-spot area DA1 to a position that can be imaged by both the right-side camera 11 and the left-side camera 12, the area (number of pixels) detected as the object Ob increases in the periphery of the blind-spot area DA1. Therefore, at steps S19 and S20 in FIG. 5, whether or not the object Ob is approaching the area ahead of the own vehicle CS in the vehicle advancing direction is determined based on the changes in area in the periphery of the blind-spot area DA1 in the visible image and the non-visible image.

At step S13 in FIG. 5, when the presence of the blind-spot area DA1 is determined based on the position of an automobile stopped on the shoulder of the road on which the own vehicle CS is traveling, whether or not the automobile is stopped may be determined based on a movement vector of the automobile. For example, the movement vector is calculated through use of known block matching or gradient method, from a plurality of right-side images Ri and left-side images Li of differing times series.

The object subject to the approach determination may be a bicycle instead of a pedestrian. In this case, at step S15 in FIG. 5, the object detection ECU 20 performs the approach determination under a condition that a bicycle is detected as the object Ob using a predetermined dictionary for bicycles. In addition, both the pedestrian and the bicycle may be subject to the approach determination.

At step S15 in FIG. 5, a movement vector indicating changes in time series of the position and speed of the object Ob present in the blind-spot area DA1 may be calculated. Whether or not the object Ob present in the blind-spot area DA1 is a moving object may be determined through use of the movement vector. In addition, when the object Ob present in the blind-spot area DA1 is moving in a direction away from the area ahead of the own vehicle CS in the vehicle advancing direction based on the calculation of the movement vector, the series of processes in FIG. 5 may be temporarily ended based on a determination that the likelihood of the object Ob approaching the area ahead of the own vehicle CS in the vehicle advancing direction is low. For example, as a method for calculating the movement vector, calculation using known block matching or gradient method can be performed. As a result of whether or not the object Ob is approaching the own vehicle CS being determined under a condition that the object Ob is a moving object that is moving or an object approaching the own vehicle CS, based on the speed and position of the object Ob, determination accuracy of the approach determination can be improved.

What is claimed is:

1. An object detection apparatus comprising:
an image acquiring unit that acquires, as a first image, a captured image of an area ahead of a vehicle in a vehicle advancing direction from a first imaging unit provided in the vehicle and acquires, as a second image, a captured image of an area ahead of the vehicle in the vehicle advancing direction from a second imaging unit provided in the vehicle;
a blind-spot determining unit that determines whether or not an object is present in a blind spot ahead of the vehicle in the vehicle advancing direction, based on the first image captured by the first imaging unit and the second image captured by the second imaging unit, the blind spot being an area that is visible through one of the first imaging unit and the second imaging unit and is not visible through the other of the first imaging unit and the second imaging unit;
an image holding unit that holds the first image captured by the first imaging unit and the second image captured by the second imaging unit in time series, when the object is determined to be present in the blind spot;
a difference acquiring unit that acquires, as a first image difference, a difference in a feature quantity between a previous image and a current image in the first image held in time series and acquires, as a second image difference, a difference in a feature quantity between a previous image and a current image in the second image held in time series; and
an approach determining unit that determines whether or not the object is approaching the area ahead of the vehicle based on the first image difference and the second image difference acquired by the difference acquiring unit.

2. The object detection apparatus according to claim 1, wherein:
one of the first image and the second image in which the object is visible in a periphery of the blind spot captured by one of the first imaging unit and the second imaging unit is set to a visible image;
the other of the first image and the second image in which the object is not visible in the blind spot is set to a non-visible image; and
the approach determining unit determines that the object is approaching the area ahead of the vehicle when, in the visible image, a state in which the object is visible is recognized as being maintained based on the first image difference and the second image difference and when, in the non-visible image, a state in which the object is not visible is recognized to have changed to a state in which the object is visible based on the first image difference and the second image difference.

3. The object detection apparatus according to claim 2, further comprising:
a moving-object determining unit that determines whether or not the object present in the periphery of the blind spot in the visible image is a moving object, when the first image captured by the first imaging unit is the visible image and the second image captured by the second imaging unit is the non-visible image, wherein
the approach determining unit determines whether or not the object is approaching the area ahead of the vehicle under a condition that the object present in the blind spot in the visible image is the moving object.

4. The object detection apparatus according to claim 1, further comprising:
a type determining unit that determines at least a pedestrian or a bicycle as a type of the object present in the blind spot, wherein
the blind-spot determining unit determines whether or not the object is present in the blind spot under a condition that the object is the pedestrian or the bicycle.

5. The object detection apparatus according to claim 2, further comprising:
a type determining unit that determines at least a pedestrian or a bicycle as a type of the object present in the blind spot, wherein
the blind-spot determining unit determines whether or not the object is present in the blind spot under a condition that the object is the pedestrian or the bicycle.

6. The object detection apparatus according to claim 3, further comprising:
a type determining unit that determines at least a pedestrian or a bicycle as a type of the object present in the blind spot, wherein
the blind-spot determining unit determines whether or not the object is present in the blind spot under a condition that the object is the pedestrian or the bicycle.

7. The object detection apparatus according to claim 1, wherein:
the blind spot includes a blind spot that is formed by a predetermined object; and
the blind-spot determining unit is configured to:
determine whether or not a blind spot formed by the predetermined object is present ahead of the vehicle in the vehicle advancing direction, based on the first image captured by the first imaging unit and the second image captured by the second imaging unit; and
determine whether or not an object is present in the blind spot formed by the predetermined object, based on the first image captured by the first imaging unit and the second image captured by the second imaging unit.

8. The object detection apparatus according to claim 1, wherein:
one of the first imaging unit and the second imaging unit is one of a right-side camera and a left-side camera, right-side camera and the left-side camera configuring a stereo camera that is mounted to the vehicle; and
the other of the first imaging unit and the second imaging unit is the other of the right-side camera and the left-side camera.

9. The object detection apparatus according to claim 1, wherein:
one of the first imaging unit and the second imaging unit is a first camera that is mounted to the vehicle; and
the other of the first imaging unit and the second imaging unit is a second camera that is mounted to the vehicle and has a wider angle of view than the first camera.

10. An object detection method comprising:
an image acquiring step of acquiring, as a first image, a captured image of an area ahead of a vehicle in a vehicle advancing direction from a first imaging unit provided in the vehicle and acquiring, as a second image, a captured image of an area ahead of the vehicle in the vehicle advancing direction from a second imaging unit provided in the vehicle;
a blind spot determining step of determining whether or not an object is present in a blind spot ahead of the vehicle in the vehicle advancing direction, based on the first image captured by the first imaging unit and the second image captured by the second imaging unit, the blind spot being an area that is visible through one of the first imaging unit and the second imaging unit and is not visible through the other of the first imaging unit and the second imaging unit;
an image holding step of holding the first image captured by the first imaging unit and the second image captured by the second imaging unit in time series, when the object is determined to be present in the blind spot;
a difference acquiring step of acquiring, as a first image difference, a difference in a feature quantity between a previous image and a current image in the first image held in time series and acquiring, as a second image difference, a difference in a feature quantity between a previous image and a current image in the second image held in time series; and
an approach determining step of determining whether or not the object is approaching the area ahead of the vehicle based on the first image difference and the second image difference acquired at the difference acquiring step.
